(19) United States
(12) Patent Application Publication
(10) Pub. No.: US 2025/0097108 A1
(43) Pub. Date: Mar. 20, 2025

(54) INTERMITTENT SYNCHRONIZATION FOR NETWORK MANAGEMENT DATA

(71) Applicant: Insight Direct USA, Inc., Chandler, AZ (US)

(72) Inventors: Benjamin Kotvis, Sussex, WI (US); David Allen Buckner, Eden Prairie, MN (US)

(21) Appl. No.: 18/470,849

(22) Filed: Sep. 20, 2023

(51) Int. Cl. H04L 41/0866; H04L 41/0816

(52) U.S. Cl. CPC H04L 41/0866; H04L 41/0816

(57) ABSTRACT

A method of network management data synchronization includes instantiating a local instance of a network management platform on an edge device and instantiating a remote instance of the network management platform on a remote server. The edge device is directly connected to a local network and to a wide area network, and the local instance of the network management platform maintains a first instance of network management data. The remote server is directly connected to the wide area network and not to the first local network, and the remote instance of the network management platform maintains a second instance of the network management data. The method further includes modifying the first instance of the network management data, providing an indication of at least one modification made to the first instance of the network management data to the remote server, and modifying the second instance of the network management data.

### FIELD OF THE INVENTION

The present disclosure relates to network systems and, more particularly, systems and methods for managing networks and for managing and synchronizing data describing networks and network devices.

### BACKGROUND

Devices connected to a local network often access resources hosted by servers and other devices connected to another network, such as a wide area network (WAN). Interruptions to the connection between the local network and the outside network can disrupt functions of devices connected to the local network that are dependent on resources, applications, programs, etc. hosted outside of the local network.

Network management platforms can be used to manage networks and network devices connected to those networks. Network management platforms are software platforms enable users, such as network administrators, to perform various network management tasks, such as monitoring, configuring, and/or controlling network devices.

### SUMMARY

An example of a method of network management data synchronization includes instantiating a local instance of a network management platform on an edge device and instantiating a remote instance of the network management platform on a remote server. The edge device is directly connected to a local network and is also directly connected to a wide area network and the local instance of the network management platform maintains a first instance of network management data, the network management data describing at least one local device connected to the first local network. The remote server is directly connected to the wide area network and not directly connected to the first local network, and the remote instance of the network management platform maintains a second instance of the network management data. The method further includes modifying, by the local instance of the network management platform, the first instance of the network management data in response to a command issued to the local instance of the network management platform and providing, by the edge device and to the remote server via the wide area network, an indication of at least one modification made to the first instance of the network management data in response to the command. The method further includes modifying, by the remote instance of the network management platform, the second instance of the network management data in response to the indication of the at least one modification provided by the edge device.

A further example of a method of network management data synchronization includes instantiating a first local instance of a network management platform on a first edge device, instantiating a second local instance of a network management platform on a second edge device, and instantiating a remote instance of the network management platform on a remote server. The first edge device is directly connected to a first local network and is also directly connected to a wide area network and the first local instance of the network management platform maintains a first instance of first network management data, the network management data describing at least one first local device connected to the first local network. The second edge device is directly connected to a second local network and is also directly connected to a wide area network and the second local instance of the network management platform maintains a first instance of second network management data, the second network management data describing at least one second local device connected to the second local network. The remote server is directly connected to the wide area network and not directly connected to either the first local network or the second local network, the remote instance of the network management platform maintains a second instance of the first network management data, and the remote instance of the network management platform maintains a second instance of the second network management data. The method further includes modifying, by the first local instance of the network management platform, the first instance of the first network management data in response to a first command issued to the first local instance of the network management platform and providing, by the first edge device and to the remote server via the wide area network, a first indication of at least one modification made to the first instance of the first network management data in response to the first command. The method yet further includes modifying, by the remote instance of the network management platform, the second instance of the first network management data in response to the first indication provided by the first edge device. The method also includes modifying, by the second local instance of the network management platform, the second instance of the second network management data in response to a second command issued to the second local instance of the network management platform and providing, by the second edge device and to the remote server via the wide area network, a second indication of at least one modification made to the second instance of the network management data in response to the second command. The method further includes modifying, by the remote instance of the network management platform, the second instance of the second network management data in response to the second indication provided by the second edge device.

An example of a system for managing networks includes an edge device connected to a wide area network and a local network and a remote server connected to the wide area network and not connected to the local network. The edge device is configured to operate a local instance of the network management platform and comprises a first processor a local instance of network management data stored on a first memory, the network management data describing at least one local device connected to the first local network. The remote server is configured to operate a remote instance of a network management platform and comprises a second processor and a remote instance of the network management data stored on a second memory. The first memory is encoded with instructions that, when executed, cause the first processor to modify the local instance of the network management data in response to a command issued to the local instance of the network management platform and provide, to the remote server and via the wide area network, an indication of at least one modification made to the first instance of the network management data in response to the command. The second memory is encoded with instructions that, when executed, cause the second processor to modify the remote instance of the network management data in response to the indication of the at least one modification provided by the edge device.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a schematic diagram of an example of a system for managing networks and synchronizing network management data.

FIG. 2 is a schematic diagram of another example of a system for managing networks and synchronizing network management data.

FIG. 3 is a flow diagram of an example of a method for synchronizing network management data.

While the above-identified figures set forth one or more examples of the present disclosure, other examples are also contemplated, as noted in the discussion. In all cases, this disclosure presents the invention by way of representation and not limitation. It should be understood that numerous other modifications and examples can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

The present disclosure relates to systems and methods for synchronizing network management data created by a network management platform. The systems and methods disclosed herein allow for multiple instances of a single network management platform to run in parallel on local and remote devices. As will be explained in more detail subsequently, the local instance of the network management platform can be used to monitor, configure, etc. a local network and/or devices thereof, and network management data describing the local network and the devices of the local network can be synchronized with a remote instance of the network management platform that is connected to a wide area network (WAN). Users can then access the remote instance of the network management platform to perform operations using the network management data without needing to directly connect to the local area network.

Existing network management platforms host all network management platform elements on a single device that is often remotely-located. When the device hosting the network management platform is inaccessible, such as when network connectivity problems (e.g., an internet outage, etc.) between a local network and the remote device occur, users (such as network administrators) are not able to access the network management platform and, accordingly, are not able to modify, create, etc. network configurations for the local network and/or devices of the local network. Advantageously, running parallel instances of a network management platform according to the present disclosure allows users connected to the local network to manage and configure local network devices using a local instance of the network management platform running on a device directly connected to the local network. That is, users are able to manage and configure local network devices without having to access a WAN-connected server. Network management data describing the local network and devices thereof can then be synchronized to a remote instance of the network management platform that enables remote users to view, manipulate, use, etc. the network management data.

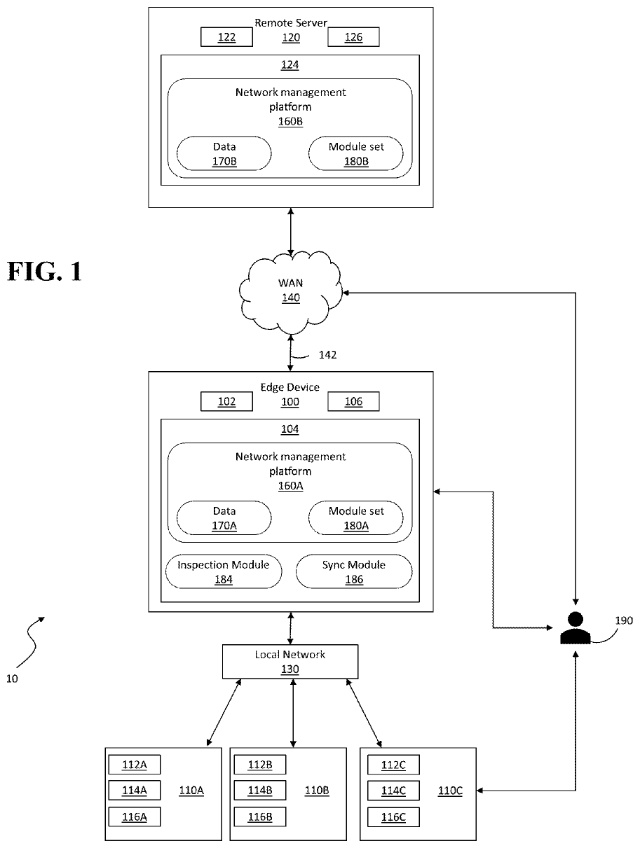

FIG. 1 is a schematic depiction of system 10, which is a system for managing networks and synchronizing network management data. System 10 includes edge device 100, local devices 110A-C. remote server 120, local network 130, WAN 140, and WAN connection 142. Edge device 100 is depicted as including processor 102, memory 104, and user interface 106; local devices 110A-C are depicted as including processors 112A-C, memories 114A-C, and user interfaces 116A-C; and remote server 120 is depicted as including processor 122, memory 124, and user interface 126. Local devices 110A-C are connected to edge device 100 via local network 130 and edge device 100 is connected to WAN 140 via WAN connection 142. Remote server 120 is also connected to WAN 140. Edge device 100 operates network management platform instance 160A and memory 104 stores application and data elements of network management platform instance 160A, including network management data 170A and module set 180A. Memory 104 also stores inspection module 184 and synchronization module 186. Remote server 120 operates network management platform instance 160B and memory 124 stores elements of network management platform instance 160B, including network management data 170A and module set 180A. FIG. 1 also depicts user 190.

Edge device 100 is a device positioned at an edge of local network 130, such that outbound network traffic from local devices 110A-C and other devices of local network 130 that is intended for WAN 140 is directed through edge device 100. Similarly, the position of edge device 100 in local network 130 causes inbound network traffic from WAN 140 that is intended for local devices 110A-C and other devices of local network 130 is directed through edge device 100. Edge device 100 includes processor 102, memory 104, and user interface 106.

Processor 102 can execute software, applications, and/or programs stored on memory 104. Examples of processor 102 can include one or more of a processor, a microprocessor, a controller, a digital signal processor (DSP), an application specific integrated circuit (ASIC), a field-programmable gate array (FPGA), or other equivalent discrete or integrated logic circuitry. Processor 102 can be entirely or partially mounted on one or more circuit boards.

Memory 104 is configured to store information and, in some examples, can be described as a computer-readable storage medium. Memory 104, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 104 is a temporary memory. As used herein, a temporary memory refers to a memory having a primary purpose that is not long-term storage. Memory 104, in some examples, is described as volatile memory. As used herein, a volatile memory refers to a memory that that the memory does not maintain stored contents when power to the memory 104 is turned off. Examples of volatile memories can include random access memories (RAM), dynamic random access memories (DRAM), static random access memories (SRAM), and other forms of volatile memories. In some examples, the memory is used to store program instructions for execution by the processor. The memory, in one example, is used by software or applications running on edge device 100 (e.g., by a computer-implemented machine-learning model or a data processing module) to temporarily store information during program execution.

Memory 104, in some examples, also includes one or more computer-readable storage media. Memory 104 can be configured to store larger amounts of information than volatile memory. Memory 104 can further be configured for long-term storage of information. In some examples, memory 104 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

User interface 106 is an input and/or output device and/or software interface, and enables an operator, such as user 190, to control operation of and/or interact with software elements of edge device 100. For example, user interface 106 can be configured to receive inputs from an operator and/or provide outputs. User interface 106 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines.

Edge device 100 operates network management platform instance 160A, which is an instance of a network management platform for managing network elements of local network 130. As used herein, “managing” a network or “managing” network devices and/or elements refers to monitoring, configuring, controlling, and/or performing other network management tasks for computerized devices connected to the network. A network management platform is a software platform that enables a user to manage a network and/or to manage network devices. A network management platform can include one or more programs, applications, etc. for enabling users to manage networks and/or network devices. Memory 104 stores program and data elements of network management platform instance 160A, including network management data 170A and module set 180A. As referred to herein, an “instance” of a program, application, data, etc. refers to an occurrence of the program, application, data, etc. on a particular device or system. Multiple instances of a program, application, data, etc. can occur on multiple discrete devices. For example, multiple instances of a program or application can be running on multiple devices. As an additional example, multiple instances of data can be stored to and/or synchronized across multiple devices.

Local devices 110A-C are electronic devices connected to local network 130 and, further, to edge device 100 via local network 130. Each of local devices 110A-N is a network device and can be, for example, a computer, a server, an electronic sensor, a printer device, a switch, a router, a network gateway, and/or a physical firewall, among other options. All of local devices 110A-C include networking capability such that each local device 110 can connect to edge device 100 and/or another component of network 130 that is in communication with edge device 100. Local devices 110A-C can be connected via a wireless and/or wired connection to edge device 100 and/or local network 130. Local devices 110A-C are depicted as including processors 112A-C, memories 114A-C, and user interfaces 116A-C. Processors 112-C, memories 114A-C, and user interfaces 116A-C are substantially similar to processor 102, memory 104, and user interface 106, respectively, and the discussion herein of processor 102, memory 104, and user interface 106 is applicable to processors 112A-C, memories 114A-C, and user interfaces 116A-C, respectively. Local devices 110A-N are directly connected to local network 130 but are not directly connected to WAN 140. As described previously, edge device 100 is located at a edge of local network 130 and is directly connected to WAN 140, such that inbound and outbound traffic to and from local devices 110A-C can be routed through edge device 100.

Remote server 120 is an electronic device connected to WAN 140 and not directly connected to local network 130. Remote server 120 stores data, executes programs, and/or performs compute tasks. Remote server 120 is generally referred to herein as a server, but it is understood that remote server 120 can be any suitable computing device for storing data, executing programs, and/or performing compute tasks. Remote server 120 is connected to WAN 140 and includes networking capability, such that remote server 120 is capable of sending and receiving network data. Remote server 120 includes processor 122, memory 124, and user interface 126, are substantially similar to processor 102, memory 104, and user interface 106, respectively, and the discussion herein of processor 102, memory 104, and user interface 106 is applicable to processor 122, memory 124, and user interface 126, respectively. Remote server 120 operates network management platform instance 160B, which is an instance of the same network management platform as network management platform instance 160A, and can be used to manage (e.g., monitor, configure, control, etc.) network elements of local network 130. Memory 104 stores program and data elements of network management platform instance 160B, including network management data 170B and module set 180B.

In at least some examples, one or more user interfaces of edge device 100, local devices 110A-C, and/or remote server 120 are a software interfaces that can be used instead of a hardware user interface to access and/or modify programs, data, and/or functionality of the respective edge device 100, local devices 110A-C, and/or remote server 120. For example, if a local device 110A-C is a server, the server may lack a dedicated hardware user interface device, and may instead include a software element that functions as a user interface for allowing a user to access, use, modify, etc. software functionality of and/or data stored to the server. As a further example, edge device 100 may be physically located such that physical access to edge device 100 is impeded or impractical. In this example, the edge device 100 can lack a hardware user interface device and can instead include a software interface to allow a user to access, use, modify, etc. software functionality of and/or data stored to edge device 100. The software interface can, for example, be accessible via network connection. As yet a further location, remote server 120 can be remotely located such that a user of system 10, such as user 190, does not have physical access to remote server 120. In these examples, remote server 120 can have a software user interface that is accessible via WAN 140 in addition to or in place of a hardware user interface device.

Local network 130 is a network that connects local devices 110A-C to edge device 100. In some examples, local network 130 can also connect local devices 110A-C to others of local devices 110A-C. Local network 130 is distinct from WAN 140 and generally connects fewer devices than WAN 140. Local devices 110A-C are not directly connected to WAN 140 and data intended for a server or other computer connected to WAN 140 is routed through edge devices 100 or another suitable edge device. Local network 130 can be wired and/or wireless networks and can each include one or more switches, routers, gateways, or other suitable network infrastructure. Local network 130 can be, for example, a local area network, a campus area network, a metropolitan area network, or another suitable network type. Generally, local network 130 connects local devices 110 that are separated by smaller geographic distances than the devices of WAN 140.

WAN 140 is a wide area network suitable for connecting servers and other computing devices that are separated by greater geographic distances than the devices of local network 130. WAN 140 includes network infrastructure for connecting devices separated by larger geographic distances. In at least some examples, WAN 140 is the Internet. Edge device 100 is connected to WAN 140 by WAN connections 142. WAN connection 142 can be a wired and/or wireless connection. In at least some examples, WAN connection 142 is a satellite connection. In operation, WAN connection 142 can be disrupted, such that edge device 100 becomes disconnected from WAN 140. In these examples, WAN connection 142 can be referred to as an “intermittent connection.” A disruption to WAN connection 142 is generally temporary but can persist for extended periods of time while repairs, maintenance, or other suitable steps are taken to restore WAN connection 142. For example, where WAN connection 142 is a wireless connection, poor signal quality can cause disruption of communication facilitated by the WAN connection 142 between the devices of local network 130 and devices of WAN 140. As a further example, where WAN connection 142 is a wired connection, mechanical damage to WAN connection 142 can disrupt communications carried by WAN connection 142. While WAN connection 142 is disrupted, local devices 110A-C and edge device 100 connected to WAN 140 by WAN connection 142 are not able to communicate with remote devices that are only available through WAN 140, such as remote server 120 and/or other devices not directly connected to the local network 130.

Edge device 100 operates network management platform instance 160A and remote server 120 operates network management platform instance 160B. Network management platform instances 160A, 160B are separate instances of a single network management platform that is capable of managing (e.g., monitoring, configuring, controlling, etc.) network elements of a local network. Network management platform instance 160A is a “local instance” of the network management platform instantiated on edge device 100 and network management platform instance 160B is a “remote instance” of the network management platform instantiated on remote server 120. Network management platform instance 160A is typically accessed only by direct connection to local network 130. For example, edge device 100 may not be accessible by users via WAN 140 (e.g., to improve network security of network 13) and/or edge device 100 may lack significant computing resources, such that use of network management platform instance 160A is only suitable for operations performed by devices that are directly connected to local network 130. Conversely, network management platform instance 160B is configured to be accessible from any device connected to WAN 140. Accordingly, network management platform instance 160B can be accessed from a wider range of physical locations than network management platform instance 160A.

Network management platform instances 160A, 160B maintain data describing the network objects of (e.g., local devices 110A-C) of local network 130 as network management data 170A, 170B. Network management data 170A, 170B can describe, for example: network hierarchies (including hierarchies of network regions, sites, and/or locations); identities of local devices 110A-C; physical locations of local devices 110A-C (e.g., rack positions, rack location, room address, etc.); wired and/or wireless connections of local devices 110A-C (e.g., cabling paths, physical port capacity and utilization, etc.); virtual machine identifiers, addresses, etc.; power distribution among local devices 110A-C; hardware configurations of local devices 110A-C; internet protocol (IP) addresses of local devices 110A-C and IP address ranges available on local network 130; virtual route forwarding (VRF) configurations of local network 130; and/or any other suitable information for describing the devices of local network 130. In least some examples, network management platform instances 160A, 160B are instances of a data center infrastructure management (DCIM) platform. As a specific example, network management platform instances 160A, 160B can be instances of NetBox. Network management platform instances 160A, 160B can use network management data 170A, 170B to push network configurations to devices of local network 130, identify faults and/or component failures of local devices 110A-C, perform inventorying tasks, and/or perform other network administration and management tasks.

Network management platform instance 160A and network management platform instance 160B include module set 180A and module set 180B, respectively. Module sets 180A, 180B include one or more program modules executable by network platforms 160A, 160B, respectively. In at least some examples, module sets 180A, 180B do not include the same program modules. For example, module set 180B of network management platform instance 160B can include more modules than module set 180A of network management platform instance 160A. Remote server 120 can include more computing resources than edge device 100 to allow remote server 120 to perform a wider variety of computing tasks and/or more complex computing tasks than edge device 100. Accordingly, module set 180B can include program modules for performing a wider variety of tasks and/or more complicated tasks than the program modules of module set 180A. For example, module set 180A can include only modules for performing network monitoring and data collection tasks, while module set 180B can include additional program modules for billing, sales, inventorying, and/or troubleshooting, among other options.

In some examples, module set 180B can lack the modules of module set 180A, such that network management platform instances 160A, 160B have non-overlapping functionality. For example, network management platform instance 160A can include all necessary modules for managing and configuring local network 130 (e.g., modules for data collection, device configuration, etc.) and network management platform instance 160B can include a separate set of modules for using the data generated by network management platform instance 160A (e.g., modules for business operations, such as finance, billing, management, etc.). In other examples, module set 180B can include all modules of module set 180A in addition to modules not possessed by module set 180A (e.g., modules for business operations), allowing network management platform instance 160B to serve as a backup and/or redundant system with network management platform instance 160A.

Inspection module 184 includes one or more programs executable by processor 102 for inspecting inbound and outbound traffic through WAN connection 142 and/or for inspecting the status WAN connection 142 and/or devices of local network 130. The status can be, for example, a connectivity status, such as the connectivity status of WAN connection 142. Edge device 100 can use the programs of inspection module 183 to determine whether to synchronize network management data 170A collected by network management platform instance 160A with network management platform instance 160B of remote server 120.

Synchronization module 186 includes one or more programs executable by processor 102 to synchronizing network management data 170A with network management platform instance 160B. Synchronization module 186 can include, for example, one or more rulesets or rules engines that can be used to identify conditions in which to synchronize network management data 170A with network management platform instance 160B. As referred to herein, “synchronizing” network management data refers to copying, updating, and/or similar activities that cause network management data 170B to be identical or substantially identical to network management data 170A. The program(s) of synchronization module 186 can cause edge device 100 to send to remote server 120 a copy of the command(s) used to modify the network management data 170A such that network management platform instance 160B can perform the same commands to make the same or substantially the same modifications to network management data 170B. Additionally and/or alternatively, the program(s) of synchronization module 186 can cause edge device to create and provide to remote server 120 a record of changes made to the network management data to allow network management platform instance 160B to make the same or substantially the same changes to network management data 170B. Additionally and/or alternatively, the program(s) of synchronization module 186 can cause edge device 100 to provide to remote server 120 copies of any data files of network management data 170A modified in response to the command and/or a copy of all data stored as network management data 170A, and network management platform instance 160B can be configured to replace files of network management data 170B with copies received by remote server 120 from edge device 100. As a specific example, if the program(s) of synchronization module 186 are configured to cause edge device 100 to periodically provide a complete copy of network management data 170A to remote server 120, network management platform instance 160B can be configured to replace network management data 170B with the received copy of network management data 170A.

Advantageously, synchronizing network management data 170A with network management platform instance 160B such that network management data 170B reproduces or substantially reproduces the data of network management data 170A allows all relevant network data describing local network 130 to be accessible through remote server 120 and does not require a user (such as user 190) to have access to local network 130 and/or edge device 100 to view, manipulate, and/or perform other tasks (e.g., business tasks) using up-to-date network management data. Further, synchronization module 186 enables automated and, in some examples, automatic synchronization of network management data 170A, 170B, reducing and/or eliminating the labor required to manually carry-over or duplicate network management data between network management platform instances 160A, 160B.

Inspection module 184 and synchronization module 186 can be integrated into network management platform instance 160A by modifying the programs of network management platform instance 160A (e.g., by modifying module set 180A) to include the programs of inspection module 184 and synchronization module 186. Alternatively, one or both of inspection module 184 and synchronization module 186 can be implemented on edge device 100 without modifying the programs of network management platform instance 160A. Rather, the programs of inspection module 184 and synchronization module 186 can be configured to run separately from network management platform instance 160A and to invoke the programs and/or functionality of network management platform instance 160A.

Network management data 170A describes network devices of local network 130, such as local devices 110A-C. User 190 can access the functionality of network management platform instance 160A by directly accessing edge device 100 (i.e., via user interface 106) and/or through a device connected to local network 130, such as one of local devices 110A-C (i.e., via the user interface 116A-C of that local device 110A-C). A user can use network management platform instance 160A to, for example, onboard a device to the network management platform, to create one or more network configurations, to access status and monitoring data regarding the devices of local network 130, to push those network configurations to the devices of network 130, etc. As used herein, “onboarding” a device to network management platform instance 160A refers to the process of creating files, profiles, etc. for the device in network management platform instance 160A. The files, profiles, etc. can describe the identity of the device, port information for the device, IP address information for the device, hardware configurations of the device, etc. Using the functionality of network management platform instance 160A can cause network management platform instance 160A to modify network management data 170A. For example, onboarding a device or adjusting a network configuration causes network management platform instance 160A to create new data or to modify existing data of network management data 170A.

Edge device 100 can use the programs of inspection module 184 and synchronization module 186 to determine if WAN-connection 142 is operative and, if so, to determine whether to synchronize network management data 170A with network management platform instance 160B such that network management data 170B includes an up-to-date copy of all data maintained as network management data 170A. Network management data 170A, 170B can be referred to as separate “instances” of network management data describing local network 130, as network management data 170B is periodically updated to be identical to or substantially identical to network management data 170A.

In some examples, edge device 100 can be configured to use the programs of inspection module 184 to determine when WAN-connection 142 is available (i.e., when WAN-connection 142 is not in an interrupted state) and to synchronize network management data using the programs of synchronization module 186 during those periods. Synchronization module 186 can cause edge device 100 to continuously synchronize network management data with remote server 120 or can cause edge device 100 to synchronize network management data on a pre-determined schedule or in pre-determined time intervals. For example, synchronization module 186 can cause edge device 100 to synchronize network management data after a pre-determined number of minutes, hours, etc.

Additionally and/or alternatively, system 10 and network management platform instances 160A, 160B can be configured such that all user requests for functionality of the network management platform are targeted or intended for network management platform instance 160B operated by remote server 120 are blocked and instead delivered to network management platform instance 160A. When user 190 is connected to local network 130, edge device 100 can inspect outgoing requests using the programs of inspection module 184 and selectively block those request and instead deliver those requests (or commands contained within those requests) to network management platform instance 160A. Modifications to network management data 170A can subsequently be synchronized with network management data 170B using the programs of synchronization module 186.

In some examples, edge device 100 can be configured to delay synchronization or to selectively synchronize the local and remote network management platform instances 160A, 160B when accessing WAN connection 142 and/or remote server 120 will incur additional charges (i.e., in examples where WAN connection 142 and/or access to remote server 120 is metered or otherwise incurs transactional charges). For example, where synchronization module 186 provides a complete copy of network management data 170A to remote server 120 if there are per-transaction costs associated with performing data operations on data stored by remote server 120 (e.g., network management data 170B), synchronization module 186 can be configured to selectively and/or periodically synchronize network management data across edge device 100 and remote server 120 to synchronize multiple changes made to network management data 170A and thereby reduce transaction costs associated with modifying remote server 120.

In operation, the instance of the network management platform running on edge device 100 (i.e., network management platform instance 160A) collects and manages network management data 170A. A user directly connected to local network 130 can use network management platform instance 160A to management local network 130 and devices connected thereto. Use of management platform instance 160A can result in modifications to network management data 170A as settings, configurations, etc. are altered. Any modifications to network management data 170A can be subsequently synchronized with network management data 170B by the program(s) of synchronization module 186 (i.e., of edge device 100). Remote users and other users not connected directly to local network 130 can then view and use (e.g., to perform reporting tasks, billing tasks, etc.) the synchronized network management data 170B by connecting to remote server 120 via WAN 140 and accessing network management platform instance 160B.

Advantageously, system 10 allows network management data from edge device 100 to be continuously and/or periodically replicated in a remote instance of the network management platform hosted by server 120 (i.e., network management platform instance 160B). Existing network management platforms host all network management platform elements on a single device. When that device is inaccessible, such as when network connectivity problems (e.g., an internet outage, etc.) cause a cloud-based or other server operating the network management platform to be unavailable, users are not able to use functionality of the network management platform. As a specific example, if a user desires to onboard a device to the network management platform while the network management platform is unavailable, the user will have to create a separate record of all relevant information for the device and manually carry-over that information into the network management platform when the network management platform is available again. Further, if the device is physically located at a remote location, the user may not be able to easily return to inspect the device to determine device-specific information (e.g., hardware configurations, etc.) that the user failed to separately record, potentially causing that device to have an incomplete or otherwise improper device record until the user is able to return to the remote site where the device is physically located. Until the device record is corrected or completed, the programs of the network management platform can encounter errors when performing, for example, management, monitoring, and/or configuration tasks.

The redundant instances of the network management platform operated by system 10 reduce the likelihood that a network outage will render network management data and the functionality of the network management platform inaccessible. More specifically, operating a second, local instance of the network management platform on edge device 100 ensures that users connected to local network 130 always have access to an instance of the network management platform. When users leave the physical area connected by local network 130, users are also able to access the same network management data and functionality through WAN 140 via the second instance of the network management platform operated by remote server 120. That is, the remote network management data instance 160B allows a user to access the network management data without being directly connected local network 130A and/or edge device 100.

Further, in examples where inspection module 184 and synchronization module 186 are implemented as separate modules and are not integrated into network management platform instance 160A, the advantages described herein can be achieved without requiring modification of an existing network management platform, potentially decreasing the time and labor required to create and configure system 10.

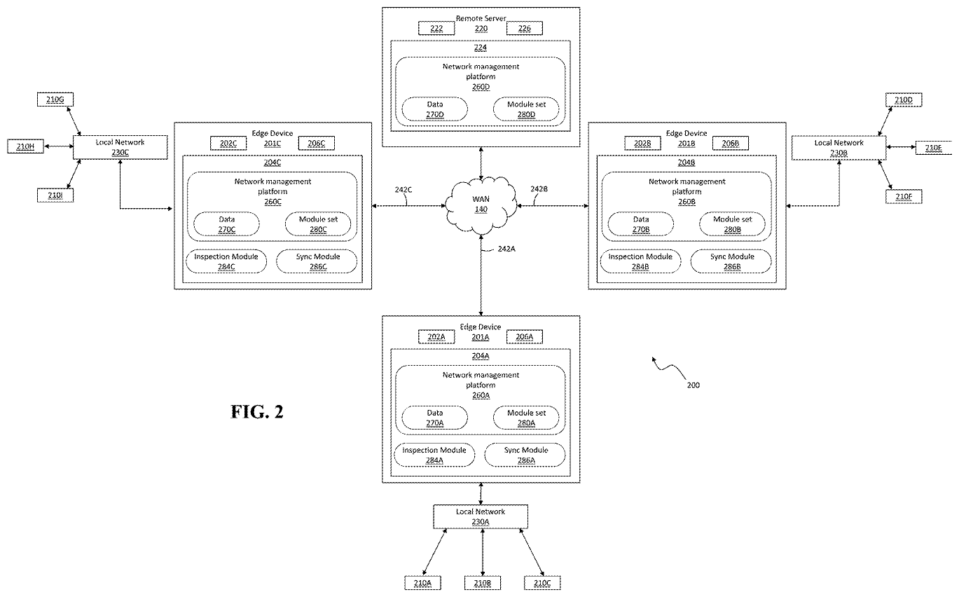

FIG. 2 is an image of system 200, which is another example of a system for creating, maintaining, and synchronizing network management data. System 10 includes edge devices 201A-C, local devices 210A-I, remote server 220, local networks 230A-C, WAN 140, and WAN connections 242A-C. System 200 is substantially similar to system 10, but includes multiple local networks each including a separate edge device, local devices, and WAN connection. Edge devices 201A-C are substantially similar to edge device 100 and local devices 210A-I are substantially similar to local devices 110A-C. System 200 is arranged such that local devices 210A-C are connected to local network 230A, local devices 210D-F are connected to local network 230B, and local devices 210G-I are connected to local network 230C. Local network 230A is connected to WAN 140 by edge device 201A, local network 230B is connected to WAN 140 by edge device 201B, and local network 230C is connected to WAN 140 by edge device 201C. Remote server 220 is substantially similar to remote server 120 and is connected to WAN 140.

Edge devices 201A-C operate network management platform instances 260A-C. respectively, and remote server 220 operates network management platform instance 260D. Network management platform instances 260A-C maintain network management data 270A-C, respectively, and include module sets 280A-C. Network management platform instance 260D maintains network management data 260D and includes module sets 280D. Network management data 270A-C is of substantially the same type as network management data 170, but network management data 270A describes network devices of local network 230A (e.g., local devices 210A-C), network management data 270B describes network devices of local network 230B (e.g., local devices 210D-F), and network management data 270C describes network devices of local network 230C (e.g., local devices 210G-I). Network management data 270D is synchronized with network management data 270A-C such that network management data 270D includes synchronized copies of network management data 270A-C created and maintained by network management platform instances 260A-C, respectively. Accordingly, a user can access and view the contents of network management data 270A-C as of the most-recent synchronization by accessing and viewing network management data 270D via WAN 140. Module sets 280A-C are substantially similar to and enable the same or similar functionality as module set 180A, and the description of module set 180 with respect to FIG. 1 is applicable to module sets 280A-C. Module set 280D is substantially similar to and enables the same or similar functionality as module set 280D, and the description of module set 180B with respect to FIG. 1 is applicable to module set 280D. Inspection modules 284A-C and synchronization modules 286A-C are substantially similar to and enable the same or similar functionality as inspection module 184 and synchronization module 186, respectively.

Edge devices 201A-C include processors 202A-C, memories 204A-C, and user interfaces 206A-C, which are substantially similar to processor 102, memory 104, and user interface 160, respectively (FIG. 1). Memory 204A stores components of network management platform instance 260A (including network management data 270A and module set 280A) as well as inspection module 284A and synchronization module 286A; memory 204B stores components of network management platform instance 260B (including network management data 270B and module set 280B) as well as inspection module 284B and synchronization module 286B; and memory 204C stores components of network management platform instance 260C (including network management data 270C and module set 280C) as well as inspection module 284C and synchronization module 286C. Remote server 220 includes processor 222, memory 224, and user interface 226, which are substantially similar to processor 122, memory 124, and user interface 126, respectively (FIG. 1). Memory 224 stores components of network management platform instance 260D, including network management data 270D and module set 280D. Processor, memory, and user interface components are not depicted in FIG. 2 for local devices 210A-for illustrative purposes and to improve clarity of the drawings, but it is understood that local devices 210A-I can include processor, memory, and user interface components that are substantially the same as processor 112A-C, memories 114A-C, and user interfaces 116A-C, respectively, as described previously with respect to FIG. 1.

WAN connections 242A-C connect edge devices 201A-C, respectively, to WAN 140. WAN connections 242A-C are each substantially similar to WAN connection 142, as described previously with respect to system 10 (FIG. 1). WAN connections 242A-C are interruptible connections to WAN 140 and are independently interruptible, such that one of WAN connections 242A-C can be interrupted without affecting the operation of others of WAN connections 242A-C. As depicted in FIG. 1, local networks 230A-C are not directly connected and instead are connected via WAN connections 242A-C and WAN 140. However, in some examples, two or more of local networks 230A-C can be directly connected and can share a WAN connection 242A-C, such that the directly-connected local networks 230A-C function as subnets of a single local network.

In operation, edge devices 201A-C operate network management platform instances 260A-C, which manage network devices of local networks 230A-C, respectively, and maintain network management data 270A-C, respectively. Edge devices 201A-C can use the programs of inspection modules 284A-C and synchronization modules 286A-C to synchronize network management data 270A-C to network management data 270D of network management platform instance 260D in the same manner as described previously with respect to network management platform instances 160A, 160B and network management data 170A, 170B (FIG. 1). A user can access network management data for any particular local network 230A-C by accessing the local network management platform instance 260A-C for that local network 230A-C or by accessing remote network management platform instance 260D operated by remote server 220. In examples where module set 280D includes modules for configuring, managing, etc. network devices, users can also push network configurations to the devices of local networks 230A-C by accessing and using the functionality of network management platform instance 260D.

System 200 is substantially similar to system 10, but includes three local networks 260A-C (rather than one) that are managed by network management platform instances 260A-C. respectively. Network management platform instance 260D is a remote instance of the network management platform that enables users to access functionality of the network management platform by accessing WAN 140. In some examples, direct access to each of local networks 230A-C requires a user to be physically on-site in a location connected by the local network 230A-C. WAN 140 is typically accessible from a wider variety of locations than local networks 230A-C and, to this extent, network management platform instance 260D allows users to control operation, configuration, etc. of network devices of local networks 230A-C and view network management data 270A-C (i.e., by viewing synchronized copies stored to network management data 270D) from a broad range of locations, including locations that are not on-site with or directly connected to any of local networks 230A-C. In examples where module set 280D includes the modules of module sets 280A-C for managing, configuring, etc. network devices, network management platform instance 280D can be used to push configurations to devices any of local networks 230A-C without requiring a user to be physically connected to or on-site at any of local networks 230A-C.

Further, system 200 provides the advantages described with respect to system 10 described previously. In particular, system 200 allows for management and configuration of local networks 230A-C when WAN connections 242A-C, respectively, are non-operational (e.g., due to be interrupted) by running separate, local instances of the network management platform on edge devices 201A-C, respectively (i.e., network management platform instances 260A-C, respectively). Network management platform instances 260A-C can be used to manage, control configure, etc. the network devices of local networks 230A-C independent of the status of WAN connections 242A-C, and edge devices 201A-C can use the programs of inspection modules 284A-C, respectively, and synchronization modules 286A-C, respectively, to synchronize network management data 270A-C, respectively, with network management data 270D when WAN 140 is available (i.e., when the respective WAN connection 242A-C is operational).

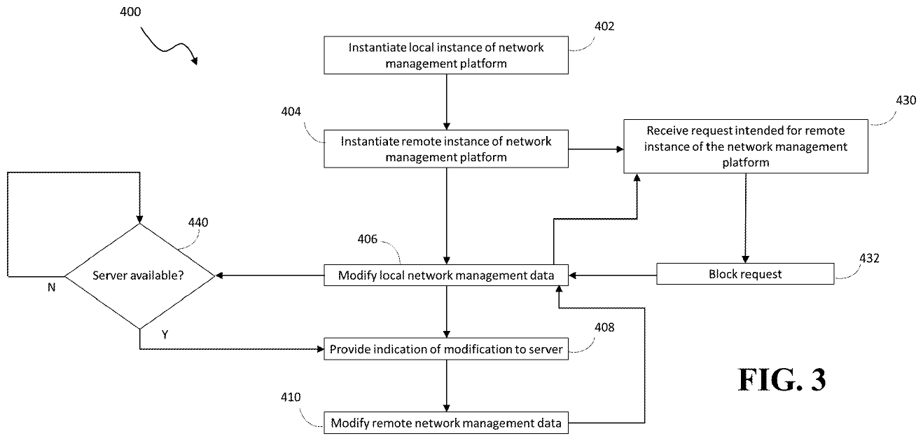

FIG. 3 is a flow diagram of method 400, which is a method of synchronizing network management data across local and remote instances of a network management platform. Method 400 includes at least steps 402-410 of instantiating a local instance of a network management platform (step 402), instantiating a remote instance of the network management platform (step 404), modifying local network management data (step 406), providing an indication of the modification to a server operating the remote instance of the network management platform (step 408), and modifying remote network management data (step 410). Method 400 can also include steps 430-440 of receiving a request intended for the remote instance of the network management platform (step 430), blocking the request (step 432), and determining whether the remote server is available (step 440). FIG. 3 can be performed by any suitable system and references to the components of systems 10, 200 (FIG. 1; FIG. 2) in the description of method 400 herein are included for clarity and explanatory purposes.

In step 402, a local instance of a network management platform is instantiated on an edge device of a local network. The edge device can be, for example, edge device 100 of local network 130 (FIG. 1) or any of edge devices 201A-C of local networks 230A-C (FIG. 2). The local instance instantiated in step 402 can be, for example, network management platform instance 160A and/or one of network management platform instances 260A-C. As referred to herein, “instantiating” an instance of a network management platform refers to executing one or more programs or otherwise starting an instance of the network management platform such that the network management platform is running and/or operating on a device.

The local instance of the network management platform includes a first module set that enable various functionality of the local instance of the network management platform (e.g., module set 180A and/or one of module sets 280A-C). The local instance of the network management platform also maintains a local instance of network management data (e.g., network management data 170A and/or one of network management data 270A-C). A user can use the local instance of the network management platform to manage (e.g., monitor, configure, control, etc.) network devices connected to the local network, such as computers, servers, electronic sensors, printer devices, network switches, routers, network gateways, and/or physical firewalls, among other options. Functionality of the local network management platform instance is determined at least in part by the modules of the module set of the network management platform instance. The local instance of the network management platform is configured to manage only the devices of the local network(s) to which the edge device operating the network management platform instance is connected. The module set used by the local network management platform instance and the network management data maintained by the local instance can be stored to, for example, one or more memories of the edge device. The edge device operating the local instance of the network management platform is WAN-connected, such that the edge device is able to transmit data to other devices connected to the WAN.

In step 404, a remote instance of the network management is instantiated on a remote server. The remote server is connected to the WAN and is not directly connected to the local network (i.e., the local network of the edge device on which the local instance is instantiated in step 402). The remote server can be, for example, remote server 120 or remote server 220 (FIG. 1; FIG. 2). The local and remote instances (i.e., the instances running on the edge device and the remote server) are of the same or substantially the same network platform. The remote instance of running on the remote server includes a module set and also maintains a remote instance of the network management data. The module sets of the remote instance and the local instance of the network management platform can be the same, substantially the same, or differ. The remote instance of the network management data is a remotely-hosted or-stored instance of the local instance of network management data maintained by the local instance of the network management platform. As will be explained in more detail subsequently, method 400 allows for period synchronization of data between the local instance of the network management data and the remote instance of the network management data.

In step 406, the local instance of the network management data is modified in response to a command issued to the local instance of the network management platform. The command can be issued by, for example, a user or another program of the edge device and/or another device connected to the local network, and causes the network management platform modify network management data describing the local network and/or devices of the local network. The network management data can be modified to, for example, add new data describing a new network device on the local network, modify an existing network configuration of an existing device, modify connectivity data for an existing device, modify a stored hardware configuration of an existing device, etc. The edge device can receive a request including the command via a user interface (e.g., user interface 106 of edge device 100) and/or from another device connected to the local network(s) to which the edge device is connected.

In step 408, the edge device provides an indication of the modification performed in step 406 to the remote server (i.e., the server operating the remote instance of the network management platform). The edge device provides the indication by sending the indication to the remote server through the WAN connecting the edge device and the remote server. The indication can include a copy of the command(s) used to modify the local instance of the network management data, a record of changes made to the network management data, copies of any data files modified in response to the command, and/or a copy of the entire local instance of the network management data, among other options. Providing less than a copy of the entire local instance of the network management data can reduce the amount of data sent from the edge device to the remote server, which, in some examples, can reduce costs associated with sending data through the WAN and/or accessing the remote server.

In step 410, the remote instance of the network management platform modifies the remote instance of the network management data according to the indication provided in step 408. More specifically, in step 410, the remote server receives the indication provided in step 408 and the remote instance of the network management platform running on the remote server uses the received indication to modify the remote instance of the network management data. The indication provide in step 408 allows the remote instance of the network management platform to modify the remote instance of the network management data to be the same or substantially the same as the local instance of the network management data (i.e., the instance modified in step 406). Where a copy of the commends used to a modify the local instance of the network management data is included in the indication, the remote instance of the network management platform can execute the command(s) or otherwise perform the operation(s) outlined by the command(s) to modify the remote instance of the network management data; where the indication is a record of changes, the remote instance of the network management platform can use the record of changes to make identical or substantially identical changes to the remote instance of the network management data; where the indication includes copies of any files modified in response to the command issued in step 406, the remote instance of the network management platform can replace corresponding files in the remote instance of the network management data with the received file copies; and where the indication includes a copy of all data maintained as the local instance of the network management data, the remote instance of the network management platform can replace the existing remote instance of the network management data with the received copy of the local instance of the network management data.

Step 410 functions to synchronize the remote instance of the network management data maintained by the instance of the network management platform operated by the remote server with changes made to the local instance of the network management data maintained by the instance of the network management platform operated by the edge device of the local network. Steps 402-410 of method 400, accordingly, allow changes to network management data to be made on an edge device of a local network and to be subsequently synced to a remote, WAN-connected device. A user can make manage a local network without requiring a WAN connection using the local instance of the network management platform. Changes made can by synchronized to a WAN-accessible instance of the network management platform, which can then be used to manage, view, and perform operations on the network management data from any device with access to the WAN. That is, synchronizing the network management data to the WAN connected device (i.e., through steps 408-410 of method 400) enables the network management data to be viewed, used, etc. without requiring a user to be directly connected to the local network and/or edge device that originally created and/or modified the network management data.

Steps 430, 432 are optional and can be included where it is desirable for software and/or commands taking advantage of the functionality of the network management platform to target the remote instance of the network management platform. For example, an existing system may include software, such as programs or applications, that are configured to target the instance of the network management platform running on the remote server. Steps 430, 432 can be performed to allow method 400 to be performed in that system without requiring those existing programs, applications, etc. to be reconfigured to target the local instance of the network management platform instantiated in step 402.

In step 430, the edge device receives a request intended for the remote instance of the network management platform (i.e., the instance instantiated in step 404). The edge device can include logic, such as one or more rulesets or rules engines, to enable the edge device to recognize requests intended for the remote instance of the network management platform. For example, the edge device can recognize the IP address of the remote server in an outgoing request and/or can inspect requests and recognize commands for the network management platform, among other options. After recognizing that a request is targeting the remote instance of the network management platform, method 400 proceeds to step 432.

In step 432, the edge device blocks the outgoing request and instead provides the request and/or commands contained within the request to the local instance of the network management platform. In some examples, the process of blocking an outgoing request and providing the request (or commands contained therein) to a new target can be referred to as “request interception.” Method 400 then proceeds to step 406 and the network management data is modified according to the commands contained within the request intercepted in step 432.

Advantageously, performance of steps 430, 432 allows method 400 and the advantages conferred thereby to be applied to systems configured to send commands to the remote instance of the network management platform rather than the local instance of the network management platform.

Notably, step 408 can be performed automatically and/or in response to modifications made to the local instance of the network management data (i.e., in response to step 406). In these examples, method 400 can proceed to step 410 immediately after performing step 408. Additionally and/or alternatively, step 408 can be performed in predetermined intervals. For example, the edge device can be configured to send an indication of all changes made within a predetermined interval or time window. For example, step 408 can be performed after a set number of hours, minutes, or days, and the indication sent in step 408 can describe all modifications made to the local instance of the network management data during that time period. Step 406 and/or steps 430, 432, 406 can be performed multiple times during the time period to incorporate multiple modifications into the local instance of the network management data. Step 408 can then be performed to provide an indication of all changes made during the iterations of step 406 and/or steps 430, 432, 406 to the remote server. Step 410 can then be performed responsively as the remote server receives the indication provided in step 408.

Step 440 is also optional and can be performed in examples where the edge device is connected to the WAN via an interruptible connection, such as WAN connection 142 and/or one of WAN connections 242A-C, and/or where access to the remote server and/or the WAN is metered or monetized (i.e., where a financial cost is associated with server access). In step 440, the edge device monitors a connectivity characteristic of the remote server to determine whether the remote server (i.e., the server running the remote instance instantiated in step 404) is available before sending the indication in step 408. Edge device 100 can use the program(s) of inspection module 184 and/or one of edge devices 201A-C can use the program(s) of inspection modules 284A-C, respectively, to determine whether the remote server is available. The monitored connectivity characteristic can be, for example, whether an interruptible connection between the edge device and the WAN is operational and/or whether access to the remote server will incur additional charges. If the connection between the edge device is not operational (i.e., is interrupted), the edge device can repeatedly and/or periodically check the status of the WAN connection to determine when the WAN connection is operational again. The edge device can proceed to step 408 from step 440 when the WAN connection is operational. Additionally and/or alternatively, if the edge device determines that access to the remote server is associated with additional costs (e.g. costs beyond an expected or permitted level per unit time), such as costs of accessing the WAN and/or cost associated with performing server operations, the edge device can delay performance of step 408. In these examples, the edge device can delay or temporarily block performance of step 408 in order to synchronize multiple changes to the remote server with a single data operation. For example, if the indication provided in step 408 is a copy of all network management data maintained of the local instance of the network management data and there are costs associated with performing data writing activities on the remote server, it can be advantageous to reduce the number of write activities and to incorporate multiple modifications to the local instance of the network management data (i.e., after multiple iterations of step 406) with a single data operation of server 120.

Steps 406-410 and any optional steps related to data management and synchronization performed pursuant to steps 406-410) (e.g., steps 430-432 and/or step 440), can be repeated multiple times to synchronize multiple changes and/or multiple sets of changes with the remote instance of the network management data.

Advantageously, method 400 allows for multiple instances of a network management platform to be instantiated. A local instance of a network management platform can be used to perform on-site operations and data created or modified using the local instance can be synchronized to a remote instance of the network management platform. Advantageously, this allows for uninterrupted operation of network management operations, including in examples where the connection between the local network and the WAN are interruptible, while also creating a remote instance of network management data that can be accessed from locations other than those directly connected by the local network managed by the local instance.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method comprising:
instantiating a local instance of a network management platform on an edge device, wherein:
the edge device is directly connected to a local network and is also directly connected to a wide area network; and
the local instance of the network management platform maintains a first instance of network management data, the network management data describing at least one local device connected to the first local network and comprising at least one of:
network hierarchies within the local network;
physical location of the local device;
identity of the local device;
power distribution of hardware within the local network;
hardware configuration of the local device; virtual machine identifiers; and
virtual route forwarding (VRF) configurations of the local network;
instantiating a remote instance of the network management platform on a remote server directly connected to the wide area network and not directly connected to the local network, wherein the remote instance of the network management platform maintains a second instance of the network management data;
modifying, by the local instance of the network management platform, the first instance of the network management data in response to a command issued to the local instance of the network management platform;
providing, by the edge device and to the remote server via the wide area network, an indication of at least one modification made to the first instance of the network management data in response to the command; and
modifying, by the remote instance of the network management platform, the second instance of the network management data in response to the indication of the at least one modification provided by the edge device.

2. The method of claim 1, wherein modifying the first instance of the network management data comprises configuring a new device connected to the local area network, the new device connected to the wide area network through the edge device.

3. The method of claim 1, wherein modifying the first instance of the network management data comprises modifying an existing configuration of an existing device connected to the local area network and connected to the wide area network through the edge device, the modification changing at least one of: a specified physical location of the local device; an identity of the local device; power distribution of affecting the local device; and hardware configuration of the local device.

4. The method of claim 1, wherein providing the indication comprises providing the indication at a pre-determined time.

5. The method of claim 1, wherein providing the indication comprises:
detecting, by the edge device, an interruption in a connection between the edge device and the wide area network;
storing, by the edge device, a copy of the indication to at least one memory of the edge device in response to detecting the interruption;
detecting, by the edge device, that the connection is restored; and
providing the stored copy of the indication to the remote server in response to detecting that the connection is restored.

6. The method of claim 1, wherein the edge device is configured to forward data received from the at least one local device to the wide area network, and wherein the edge device is further configured to forward data received from the wide area network to the at least one first local device.

7. The method of claim 1, wherein the command is intended to be issued to the remote instance of the network management platform and modifying the first instance of the network management data comprises:
receiving, by the edge device, a request to the remote server, the request comprising the command;
blocking, by the edge device, the request to the remote server; and
issuing, by the edge device, the command to the local instance of the network management platform.

8. The method of claim 7, wherein receiving the command comprises receiving the command from a device connected to the local area network.

9. The method of claim 7, wherein blocking the request comprises:
detecting, by the edge device, an interruption in a connection between the edge device and the wide area network; and
blocking the request to the remote server in response to detecting the interruption.

10. The method of claim 9, wherein providing the indication to the remote server comprises:
detecting that the connection between the edge device and the wide area network is restored; and
providing the indication in response to detecting that the connection is restored.

11. The method of claim 1, wherein the network management platform is a data infrastructure management platform.

12. The method of claim 1, wherein:
instantiating the local instance of the network management platform comprises instantiating a first set of modules of the network management platform,
instantiating the remote instance of the network management platform on the remote server comprises instantiating a second set of modules of the network management platform, and
the first set of modules and the second set of modules are not identical.

13. The method of claim 12, wherein:
the second set of modules includes all modules of the first set of modules, and the first set of modules does not include all modules of the second set of modules.

14. The method of claim 1, wherein providing the indication of the at least one modification comprises providing a record of changes to the first instance of the network management data.

15. The method of claim 1, wherein:
the network management data comprises a plurality of data files,
modifying the first instance of the network management data comprises modifying at least one data file of the plurality of data files of the first instance without modifying a remainder of the data files of the plurality of data files of the first instance, and
providing the indication of the at least one modification comprises providing the modified at least one data file of the plurality of data files.

16. The method of claim 1, wherein providing the indication of the at least one modification comprises providing a copy of the first instance of the network management data to the remote server.

17. The method of claim 1, wherein providing the indication of the at least one modification comprises determining, before providing the indication, that the indication should be provided to the remote server based on a connectivity characteristic of the remote server, wherein the connectivity characteristic is an operational status of a connection between the edge device and the wide area network.

18. (canceled)

19. A method comprising:
instantiating a first local instance of a network management platform on a first edge device, wherein:
the first edge device is directly connected to a first local network and is also directly connected to a wide area network, and
the first local instance of the network management platform maintains a first instance of first network management data, the first network management data describing at least one first local device connected to the first local network;
instantiating a second local instance of a network management platform on a second edge device, wherein:
the second edge device is directly connected to a second local network and is also directly connected to a wide area network, and
the second local instance of the network management platform maintains a first instance of second network management data, the second network management data describing at least one second local device connected to the second local network;
instantiating a remote instance of the network management platform on a remote server directly connected to the wide area network and not directly connected to either the first local network or the second local network, wherein:
the remote instance of the network management platform maintains a second instance of the first network management data,
the remote instance of the network management platform maintains a second instance of the second network management data;
modifying, by the first local instance of the network management platform, the first instance of the first network management data in response to a first command issued to the first local instance of the network management platform;
providing, by the first edge device and to the remote server via the wide area network, a first indication of at least one modification made to the first instance of the first network management data in response to the first command;
modifying, by the remote instance of the network management platform, the second instance of the first network management data in response to the first indication provided by the first edge device;
modifying, by the second local instance of the network management platform, the second instance of the second network management data in response to a second command issued to the second local instance of the network management platform;
providing, by the second edge device and to the remote server via the wide area network, a second indication of at least one modification made to the second instance of the second network management data in response to the second command; and
modifying, by the remote instance of the network management platform, the second instance of the second network management data in response to the second indication provided by the second edge device.

20. A system for managing networks, the system comprising:
an edge device connected to a wide area network and a local network, the edge device configured to operate a local instance of a network management platform, and comprising:
a first processor; and
a local instance of network management data stored on a first memory, the network management data describing at least one local device connected to the first local network; and
a remote server connected to the wide area network and not connected to the local network, the remote server configured to operate a remote instance of the network management platform and comprising:
a second processor; and
a remote instance of the network management data stored on a second memory;
wherein the first memory is encoded with instructions that, when executed, cause the first processor to:
modify the local instance of the network management data in response to a command issued to the local instance of the network management platform; and
provide, to the remote server and via the wide area network, an indication of at least one modification made to the first instance of the network management data in response to the command; and
wherein the second memory is encoded with instructions that, when executed, cause the second processor to modify the remote instance of the network management data in response to the indication of the at least one modification provided by the edge device.

21. The method of claim 1, wherein the network management data comprises network configuration data for a data center infrastructure management (DCIM) platform.
